(19) United States
(12) Patent Application Publication
(10) Pub. No.: US 2012/0044094 A1
(43) Pub. Date: Feb. 23, 2012

(54) R-RATED GPS VOICE RESPONSE

(76) Inventor: DAVID YEGGE, Portland, OR (US)

(21) Appl. No.: 12/860,884

(22) Filed: Aug. 21, 2010

(51) Int. Cl. G08G 1/123

(52) U.S. Cl. 340/990

(57) ABSTRACT

A GPS voice command system comprising: mapping and direction software residing on a memory device; a visual display means; and a series of voice commands associated with directions provided by the GPS system, where the series of voice commands include the comical and profane phrases for entertainment purposes.

### BACKGROUND OF THE INVENTION

1. Field of Invention

The present invention relates to a GPS response system that provides colorful language while providing driving instructions for entertainment purposes.

2. Description of Related Art

GPS systems are currently used in many vehicles to provide driving directions for the driver. GPS systems provide a visual layout and mapping of the directions to a particular point as input by the user. GPS systems also can visually pinpoint the location of an individual or vehicle on mapped screen. In addition to providing a layout of the directions on a small screen, a GPS system may also use voice commands to help direct the user to follow the appropriate directions provided. Many times the voice responses relate to simply a left turn approaching, right turn approaching, U turn approaching, etc. Further some GPS systems alert the user of upcoming traffic situations and provide a means of avoidance thereof. Although some forms of voice commands are provided it would be entertaining to have comical or even profane language included in the voice response system. Such catch phrases could be input into the voice command software to coincide with certain actions taken in relation to the directions provided by the GPS system.

### SUMMARY OF THE INVENTION

The present invention relates to a GPS voice command system comprising: mapping and direction software residing on a memory device; a visual display means; and a series of voice commands associated with directions provided by the GPS system, where series of voice commands include the comical and profane phrases for entertainment purposes.

### BRIEF DESCRIPTION OF DRAWINGS

FIG. 1 depicts a standard GPS display device according to the present invention.

### DETAILED DESCRIPTION

The present invention relates to a software voice-command system that includes the use of colorful language and even profane comments in relation to directions and vehicle guidance provided by a GPS system. The GPS system according to present invention actually provides colorful or comical language that may entertain the user while utilizing a GPS system. The GPS system provides a series of preprogrammed comments related to driving directions provided by the GPS system.

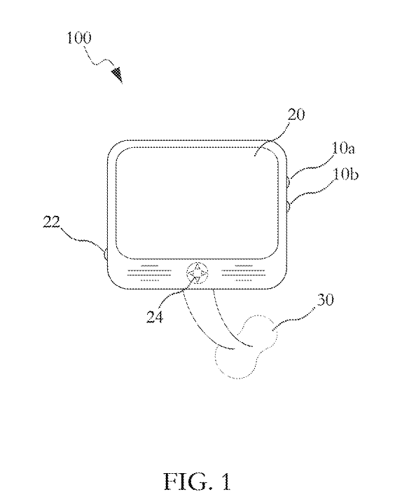

FIG. 1 depicts a standard GPS System 100 according to the present invention. The GPS system 100 includes a GPS Screen 20, Input Direction Device 24, an on and off switch 22, and volume control Buttons 10A, 10B. The GPS Device 100 according to present invention may be mounted through the use of a Mounting Arm 30. Software system residing in a memory device within the GPS system 100 provides playback of voice commands related to directions provided by the GPS system 100. The GPS system 100 functions as a normal GPS system providing directions for the user however upon the mistakes or incorrect procedures used by the driver the GPS system 100 can alert the driver through the use of an insulting or rude remark for comical purposes. The insulting voice command would alert the driver through the use of these comical or profane comments that a mistake had been made with respect to the driving of the vehicle. This software system provides a means to customize certain comments as desired by the user and therefore helps to provide some type of comic relief for the driver using the GPS system 100. Instead of just providing simple turn or signal commands the GPS system 100 would include the use of these comical or profane phrases to catch the driver's attention.

The instant invention has been shown and described in what it considers to be the most practical and preferred embodiments. It is recognized, however, that departures may be made there from within the scope of the invention and that obvious modifications will occur to a person skilled in the art.

What is claimed is:

1. A GPS voice command system comprising:
a. mapping and direction software residing on a memory device;
b. a visual display means; and
c. a series of voice commands associated with directions provided by the GPS system, where the series of voice commands include the comical and profane phrases for entertainment purposes.
